(19) United States
(12) Patent Application Publication
(10) Pub. No.: US 2022/0150598 A1
(43) Pub. Date: May 12, 2022

(54) METHOD FOR MESSAGE INTERACTION, AND ELECTRONIC DEVICE

(71) Applicant: BEIJING DAJIA INTERNET INFORMATION TECHNOLOGY CO., LTD., Beijing (CN)

(72) Inventors: Pengyan YAO, Beijing (CN); Mengtian LV, Beijing (CN); Xueting ZHAO, Beijing (CN); Caiwang CHEN, Beijing (CN); Shuli GUO, Beijing (CN); Chen WANG, Beijing (CN)

(21) Appl. No.: 17/479,238

(22) Filed: Sep. 20, 2021

(30) Foreign Application Priority Data
Nov. 10, 2020 (CN) 202011249611.1

(51) Int. Cl. H04N 21/488; H04N 21/2187; H04N 21/2668; H04N 21/475

(52) U.S. Cl. CPC H04N 21/4882; H04N 21/475; H04N 21/2668; H04N 21/2187

(57) ABSTRACT

Provided is a method for message interaction. The method includes: receiving at least one first interaction message sent from an audience client in a live-streaming room; displaying the at least one first interaction message on a message processing page; acquiring a second interaction message for a target interaction message in response to a message processing instruction on the target interaction message, wherein the target interaction message includes a first interaction message selected on the message processing page; and sending the second interaction message to a target audience client in response to a message sending instruction on the second interaction message, wherein the target audience client includes an audience client sending the target interaction message.

### CROSS-REFERENCE TO RELATED APPLICATION

This application is based on and claims priority to Chinese Patent Application No. 202011249611.1, filed on Nov. 10, 2020, the disclosure of which is herein incorporated by reference in its entirety.

### TECHNICAL FIELD

The present disclosure relates to the field of internet technologies, and in particular, relates to a method for message interaction, and an electronic device.

### BACKGROUND

At present, the interaction between anchors and audiences can he supported during a video live-streaming process. For example, an anchor in a live-streaming room can interact with the audience by browsing messages sent by the audience in a comment region.

Currently, the messages sent by the audience in the live-streaming room are directly sent and displayed in a preset comment region on a page of the live-streaming room.

### SUMMARY

The present disclosure provides a method for message interaction and an electronic device. The technical solutions of the present disclosure are as follows.

In an aspect, a method for message interaction is provided. The method is applicable to a message processing client and includes:

receiving at least one first interaction message, wherein the at least one first interaction message is sent from an audience client in a live-streaming room;

displaying the at least one first interaction message on a message processing page;

acquiring a second interaction message for a target interaction message in response to a message processing instruction on the target interaction message, wherein the target interaction message includes a first interaction message selected on the message processing page; and

sending the second interaction message to a target audience client in response to a message sending instruction on the second interaction message, wherein the target audience client includes an audience client sending the target interaction message.

In another aspect, an apparatus for message interaction is provided. The apparatus is applicable to a message processing client, and includes:

a receiving module, configured to receive at least one first interaction message, wherein the at least one first interaction message is sent from an audience client in a live-streaming room;

a displaying module, configured to display the at least one first interaction message on a message processing page;

a message processing module, configured to acquire a second interaction message for a target interaction message in response to a message processing instruction on the target interaction message, wherein the target interaction message includes a first interaction message selected on the message processing page; and

a sending module, configured to send the second interaction message to a target audience client in response to a message sending instruction on the second interaction message, wherein the target audience client includes an audience client sending the target interaction message,

In another aspect, an electronic device is provided. The electronic device includes:

a processor; and a memory configured to store at least one instruction executable by the processor;

wherein the processor, when loading and executing the at least one instruction, is caused to perform:

receiving at least one first interaction message, wherein the at least one first interaction message is sent from an audience client in a live-streaming room;

displaying the at least one first interaction message on a message processing page;

acquiring a second interaction message for a target interaction message in response to a message processing instruction on the target interaction message, wherein the target interaction message includes a first interaction message selected on the message processing page; and

sending the second interaction message to a target audience client in response to a message sending instruction on the second interaction message, wherein the target audience client includes an audience client sending the target interaction message.

In another aspect, a non-transitory storage medium storing at least one instruction therein is provided, wherein the at least one instruction, when loaded and executed by a processor of an electronic device, causes the electronic device to perform:

receiving at least one first interaction message, wherein the at least one first interaction message is sent from an audience client in a live-streaming room;

displaying the at least one first interaction message on a message processing page;

acquiring a second interaction message for a target interaction message in response to a message processing instruction on the target interaction message, wherein the target interaction message includes a first interaction message selected on the message processing page; and

sending the second interaction message to a target audience client in response to a message sending instruction on the second interaction message, wherein the target audience client includes an audience client sending the target interaction message.

In another aspect, a computer program product including a computer program stored in a readable storage medium is provided, wherein the computer program, when read and executed by at least one processor of an electronic device from the readable storage medium, causes the electronic device to perform:

receiving at least one first interaction message, wherein the at least one first interaction message is sent from an audience client in a live-streaming room;

displaying the at least one first interaction message on a message processing page;

acquiring a second interaction message for a target interaction message in response to a message processing instruction on the target interaction message, wherein the target interaction message includes a first interaction message selected on the message processing page; and

sending the second interaction message to a target audience client in response to a message sending instruction on the second interaction message, wherein the target audience client includes an audience client sending the target interaction message.

### BRIEF DESCRIPTION OF THE DRAWINGS

The accompanying drawings, which are incorporated in and constitute a part of this description, illustrate embodiments consistent with the present disclosure and, together with the description, serve to explain the principles of the present disclosure, and do not constitute an improper limitation of the present disclosure.

FIG. 1 is an application environment diagram of a method for message interaction according to an embodiment of the present disclosure;

FIG. 2 is a flowchart of a method for message interaction according to an embodiment of the present disclosure;

FIG. 3 is a schematic diagram of triggering a message reply operation on a message processing page according to an embodiment of the present disclosure;

FIG. 4 is a schematic diagram of replying to a target interaction message according to an embodiment of the present disclosure;

FIG. 5 is a schematic diagram of a live-streaming page displayed at an audience client according to an embodiment of the present disclosure;

FIG. 6 is a schematic diagram of a message processing page of a third-party client according to an embodiment of the present disclosure;

FIG. 7 is a schematic diagram of a live-streaming page displayed at an audience client according to an embodiment of the present disclosure;

FIG. 8 is a schematic diagram of a message processed page according to an embodiment of the present disclosure;

FIG. 9 is a schematic diagram of a message processed page according to an embodiment of the present disclosure;

FIG. 10 is an interaction diagram of a method for message interaction according to an embodiment of the present disclosure;

FIG. 11 is a schematic diagram of sending a first interaction message by an audience client according to an embodiment of the present disclosure;

FIG. 12 is a schematic diagram showing details of message processing after the end of live-streaming according to an embodiment of the present disclosure;

FIG. 13 is a block diagram of an apparatus for message interaction according to an embodiment of the present disclosure; and.

FIG. 14 is an internal structure diagram of an electronic device according to an embodiment of the present disclosure.

### DETAILED DESCRIPTION

To make those of ordinary skill in the art understand the technical solutions of the present disclosure better, the technical solutions in the embodiments of the present disclosure are clearly and completely described in the following with reference to the accompanying drawings.

During a video live-streaming process, an anchor in a live-streaming room can interact with the audience by browsing messages sent by the audience in a comment region. In the related art, the messages sent by the audience in the live-streaming room are directly sent and displayed in a preset comment region on a page of the live-streaming room. Since a large number of messages are displayed in a comment region, some important messages are easily overlooked and missed by the anchor as the messages are constantly refreshed. Especially for a live-streaming room with a lot of audiences, such as an e-commerce live-streaming room in some circumstances, due to the huge volume of audience messages and a high refresh rate, it is likely that the anchor fails to notice and reply some important messages, leading to lower message processing efficiency.

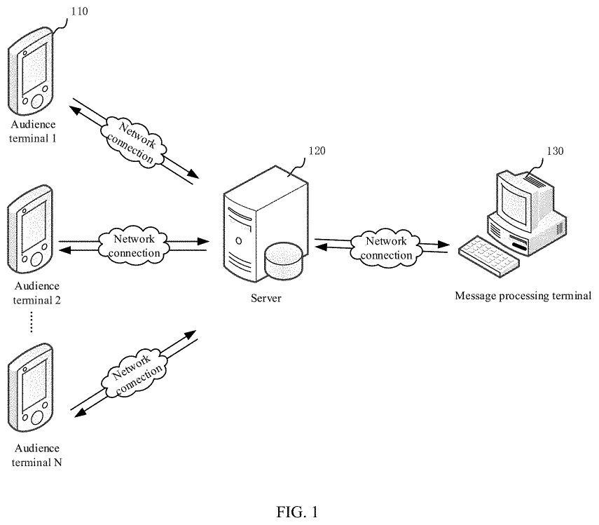

A method for message interaction according to the present disclosure is applicable to an application environment shown in FIG. 1. Here, at least one audience terminal 110 communicates with a server 120 by a network; and a message processing terminal 130 communicates with the server 120 by the network. The audience terminal 110 is installed with an application program that can be used for watching live-streaming. The message processing terminal 130 is installed with an application program that can be used for processing messages, and the application program for processing messages is an auxiliary application of the live-streaming application program. The message processing terminal 130 is an auxiliary terminal corresponding to an anchor terminal, and is associated with the anchor terminal by the same account or different accounts, and is managed by other people (hereinafter referred to as a message processor) besides an anchor during the live-streaming. The audience terminal 110, the message processing terminal 130 and the anchor terminal are disposed in the same system, and data interaction can be performed between any two terminals.

In some embodiments, a live-streaming page in a live-streaming room is displayed at the audience terminal 110, and a message interaction control is displayed on the live-streaming page. In the case that an audience wants to send an ordinary message to the live-streaming room, such as a bullet-screen comment to the live-streaming room, he/she can send the message directly on the live-streaming page of the live-streaming room without activating the message interaction control. In the case that the audience wants to send a message required to be responded to, a first interaction message is input onto the live-streaming page of the live-streaming room when the message interaction control is in an activated state, the first interaction message is sent to the server 120 by the audience terminal 110, and is further sent to the message processing terminal 130 by the server 120. The first interaction message is displayed on a message processing page after the message processing terminal 130 receives the first interaction message from the at least one audience terminal 110, and a message processor processes the first interaction message. In some embodiments, the audience terminal 110 includes but is not limited to various personal computers, notebook computers, smart phones and tablet computers. The server 120 is an independent server or a server cluster composed of a plurality of servers. The message processing terminal 130 includes but is not limited to various personal computers, notebook computers, smart phones and tablet computers.

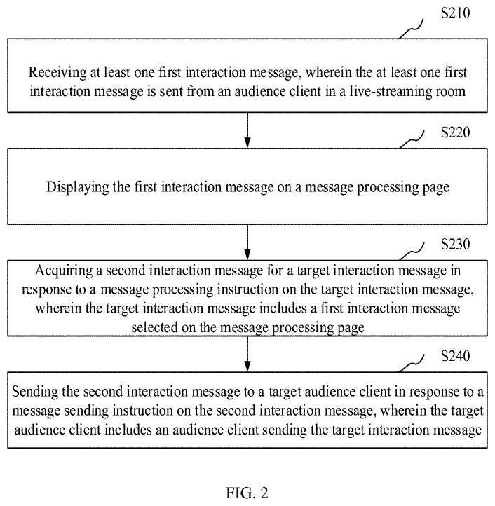

FIG. 2 is a flowchart of a method for message interaction according to an embodiment of the present disclosure. As shown in FIG. 2, the method for interacting the messages is applicable to a message processing terminal 130 and includes the following steps.

In S210, at least one first interaction message sent from an audience client in a live-streaming room is received.

Here, the first interaction message refers to a message that an audience wants to send to a message processing client for processing by an audience client, and may be one or a combination of a text, speech, an image, a link, a video, etc. but is not limited to these examples. In some embodiments, the message processing client may also be called an auxiliary client of an anchor. A message processor can process messages that the anchor fails to process.

In some embodiments, the at least one first interaction message is sent from the audience client in the live-streaming room when a message interaction control is in activated state. The message interaction control is displayed on a live-streaming page in the live-streaming room, and is configured to send the message to the message processing client which is a client associated with an anchor client in the live-streaming room.

The live-streaming page includes a live-streaming video picture of the anchor, such as a live-streaming page in any scene such as e-commerce live-streaming and game live-streaming. The anchor triggers a creation request of the live-streaming room by the anchor client, and the anchor client creates the live-streaming room in response to the creation request of the live-streaming room. In a live-streaming process, the anchor client collects live-streaming video streams in real time to generate the live-streaming page. That is, the anchor client sends the collected live-streaming video streams to a server, the server transcodes the live-streaming video streams, and the live-streaming page is generated based on the transcoded live-streaming video streams.

The message interaction control is a control with which the audience can interact to send the first interaction message to the message processing client for processing. The message interaction control may be displayed at any position of the live-streaming page in a form of a fixed control, or in a form of a floating button, or the like but is not limited to these display manners. The activated state of the message interaction control refers to a state in which the audience client can interact with the message processing client. In some embodiments, after being clicked, the message interaction control can be in the activated state. In some embodiments, a display effect of the message interaction control can be changed before and after the message interaction control is activated. For example, the message interaction control is gray before it is activated, and is colored after it is activated. The audience can know whether the message interaction control is activated based on this color change.

In some embodiments, the audience client may enter the live-streaming room by searching, hot spot recommendation, etc. The audience client receives the live-streaming video streams sent from the server in real time, displays the live-streaming page of the live-streaming room, and displays the message interaction control on the live-streaming page. In the case that the audience wants to send the first interaction message to the message processing client, he/she clicks the message processing control to enable the message processing control to be in the activated state. In the case that the message processing control is in the activated state, the audience inputs the first interaction message via the audience client. After the audience completes editing the first interaction message, a message sending instruction is triggered by the audience client. In response to the message sending instruction, the audience client sends the first interaction message to the server, and the server sends the first interaction message to the message processing client.

In some embodiments, the server sends the first interaction message to the anchor client, such that the anchor can know the needs of the audience in time.

In some embodiments, in the case that the message interaction control is in an inactivated state, the audience client sends the first interaction message to the server after receiving the first interaction message. The server sends the first interaction message to the anchor client and all audience clients that have entered the live-streaming room, such that the anchor can interact with audiences based on the first interaction message.

In S220, the at least one first interaction message is displayed on a message processing page.

Here, the message processing page refers to a page where the first interaction message can be displayed and processed, and the message processor can view the first interaction message sent by the audience on the message processing page. In some embodiments, the message processor may further select a target interaction message required to be replied from the message processing page, and reply to the target interaction message.

In S230, a second interaction message for a target interaction message is acquired in response to a message processing instruction on the target interaction message, wherein the target interaction message includes a first interaction message selected on the message processing page.

The target interaction message refers to the first interaction message selected to be processed. The second interaction message is a message generated after processing the target interaction message by the message processing client, and is not limited to one or a combination of a text, speech, an image, a link, a video, etc.

In some embodiments, after receiving the first interaction messages sent from the audience client during the live-streaming, the message processing client updates the first interaction messages to the message processing page in real time. In some embodiments, the first interaction messages on the message processing page are displayed in a form of a session list. In some embodiments, a plurality of first interaction messages from the same audience client is displayed in an aggregated fashion or is displayed in a form of a message list. In some embodiments, the first interaction messages from different audience clients are displayed in a tiled fashion based on a time sequence of the received first interaction messages.

In some embodiments, there are ninny ways for the message processing client to process the target interaction message, such as reply and forwarding in some embodiments. The message processing way may be pre-configured, such that the message processing client can automatically: for example, configure a message processing way as automatic reply after receiving the first interaction message. Content of the automatic reply is set by a message processor according to an actual situation. After receiving the first interaction message, the message processing client can automatically reply to the first interaction message with the content. Alternatively, the message processing way is manually configured by the message processor according to a requirement. That is, the message processor manually replies to the first interaction message. After acquiring the target interaction message selected by the message processor, the message processing client processes the target interaction message according to the configured message processing way to generate a second interaction message. Here, when the message processor selects the target interaction message by a selection operation on the message processing page, namely, by selecting the at least one first interaction message displayed on the message processing page; and the first interaction message as selected is the target interaction message. The server sends the second interaction message to a target audience client corresponding to the target interaction message, such that the target audience client can display the second interaction message on a current live-streaming page.

In the above method for interacting the messages, after receiving at least one first interaction message sent from an audience client in a live-streaming room when a message interaction control is in the activated state, a message processing client displays the at least one first interaction message on a message processing page. In response to a message processing instruction on a target interaction message in the at least one first interaction message, a second interaction message for the target interaction message is acquired. As the audience messages are processed in time by the message processing client capable of focusing on processing the audience messages, the processing efficiency of the audience messages is improved, which facilitates the improvement of an interaction effect in the live-streaming room, thereby an audience may want further interactions and stay for a longer time in watching live-streaming. Further, as the message interaction control is provided on the live-streaming page of the audience client, the audience can send the first interaction message required to be responded to the message processing client according to a need, such that the message processing is flexible.

In some embodiments, in S230, in response to a triggering operation on the message processing control corresponding to the target interaction message, the second interaction message for the target interaction message is acquired by processing the target interaction message. That is, the message processing instruction is received by the message processing control.

Here, the message processing control is a control with which the message processor can interact to indicate the message processing way that the message processing client should adopt. In some embodiments, the message processing control is a message reply control, a message forwarding control, or the like. Here, the message reply control is a control for replying to the target interaction message; and the message processor can input the reply to the target interaction message at the message processing client after he/she clicks the message reply control. The message forwarding control is a control for forwarding the target interaction message; and the message processor can forward the target interaction message to another message processor by the message processing client after he/she clicks the forwarding control, such that the other message processor can process the target interaction message.

In some embodiments, for each of the first interaction messages as received, the message processing control corresponding to the first interaction message is displayed on the message processing page. After the target interaction message is determined from the message processing page, the message processor triggers the message processing control corresponding to the target interaction message, such that the message processing client can receive the message processing instruction. The message processing client acquires the second interaction message by the message processing way corresponding to the message processing instruction to process the target interaction message.

By configuring the corresponding message processing control for each first interaction message, it is convenient for the message processor to reply to each first interaction message independently/individually, thereby improving the flexibility and operability in message processing.

In some embodiments, the message processing instruction is a message reply instruction. In S230, the second interaction message is acquired by a message reply input box in response to the message reply instruction, and the message reply input box is displayed in a message reply region on the message processing page.

Here, the message processing client, as an auxiliary terminal of the anchor client, can he configured to reply to the first interaction message sent from the audience client.

In some embodiments, the message processor triggers the message reply control corresponding to the target interaction message, such that the message processing client can receive the message reply instruction by means of the message reply control. The message processing client displays the message reply input box in the message reply region on the message processing page. The second interaction message is acquired by means of the message reply input box. That is, the second interaction message input by the message processor in the message reply input box is acquired. After a message sending instruction on the second interaction message triggered by the message processor is received, the second interaction message is sent to the server, and the server sends the second interaction message to the target audience client.

In S240, the second interaction message is sent to the target audience client in response to a message sending instruction on the second interaction message, wherein the target audience client includes an audience client sending the target interaction message.

In some embodiments, after receiving the second interaction message, the target audience client can display the second interaction message on the live-streaming page of the live-streaming room.

In some embodiments, the message sending instruction is automatically triggered by the message processing client or manually triggered by the message processor. In some embodiments, the message processing client directly generates the second interaction message. For example, the message processor inputs a reply message for the target interaction message by the message processing client, or the message processing client. automatically sends prompt information. After acquiring the second interaction message for the target interaction message, the message processing client sends the second interaction message to the server in response to the message sending instruction on the second interaction message; and the server sends the second interaction message to the target audience client, such that the target audience client displays the second interaction message on the current live-streaming page.

As the message processing client directly generates and sends the second interaction message, the audience messages can be processed quickly, thereby improving the processing efficiency of the audience messages.

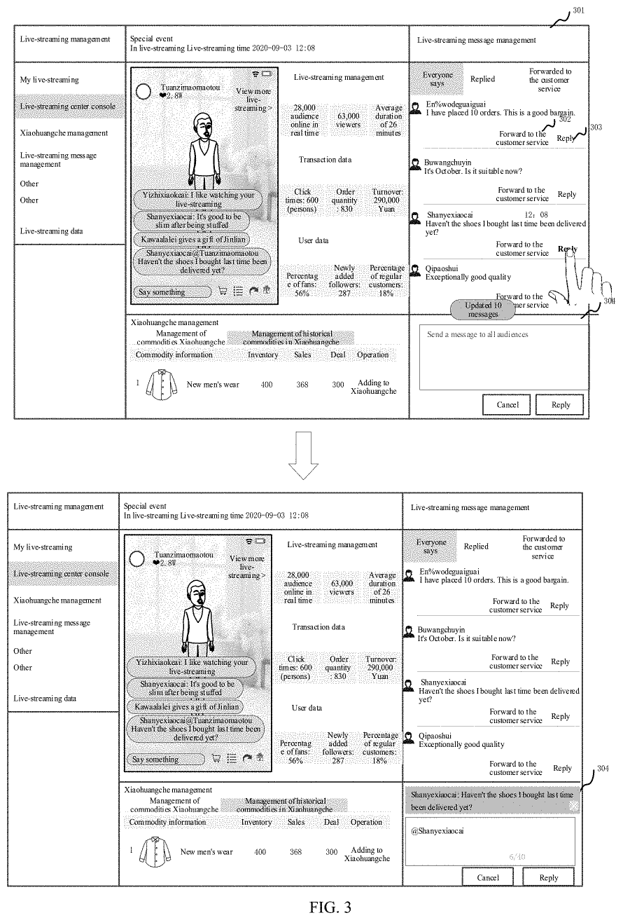

FIG. 3 is a schematic diagram of a message processing page according to an embodiment of the present disclosure. As shown in FIG. 3, the first interaction messages sent from the audience client are displayed on the message processing page 301 in the form of a message list. Each first interaction message corresponds to a set of message processing controls. For example, a set of message processing controls includes a message forwarding control 302 (such as “Forward to the customer service” in FIG. 3) and a message reply control 303 (such as “Reply” in FIG. 3). The message processor triggers the message reply control 303 corresponding to the target interaction message, such that the message processing client receives the message reply instruction.

In some embodiments, in response to the message reply instruction, the message processing client forms a message reply input box by reducing an original input box in the message reply region 304 for display. The second interaction message is acquired via the message reply input box, and is sent to the server; and the server sends the second interaction message to the target audience client.

In some embodiments, the message processing client sorts the received first interaction messages according to a receiving time sequence thereof. For example, the first interaction message as received latest is displayed at the top of the message processing page. After receiving a new message, the message processing client displays prompt information (referring to “Updated 10 messages” in FIG. 3) to prompt the message processor to view the new message in time. The message processing client automatically scrolls to the first interaction message as received latest in response to detecting that the message processor does not perform the message viewing operation within a preset period.

In some embodiments, in response to detecting that a selection element (such as a mouse or a finger) is disposed at the message processing control, the message processing client adjusts a display state of the message processing control, such as highlighting the message processing control, so as to prompt the message processor to perform message processing by triggering the message processing control.

As the message processing client is capable of focusing on processing the audience messages, the audience messages can be processed in time, thereby improving the processing efficiency of the audience messages.

In some embodiments, interaction reply content and an identifier of the target audience client are acquired by the message reply input box, wherein the identifier is added into the message reply input box based on the message reply instruction; and the second interaction message is generated based on the identifier and the interaction reply content.

Here, the identifier of the target audience client is not limited to information such as an account nickname and an account. The interaction reply content is content input by the message processor by means of the message reply input box, and is not limited to one or a combination of a text, speech, an image, a link, a video, etc.

In some embodiments, after the message processor triggers the message reply operation on the target interaction message, the message processing client acquires an identifier corresponding to the target audience client and adds the identifier of the target audience client to the message reply input box. In some embodiments, the identifier of the target audience client is account information of the target audience client. The message processing client continues to acquire interaction reply content by means of the message reply input box, and generates the second interaction message based on the interaction reply content and the identifier of the target audience client. Taking the account information of the target audience client as the account nickname, for example, when the message processor replies to the target interaction message, the account nickname can be displayed in the message reply input box, and the interaction reply content input by the message processor in the message reply input box is displayed behind the account nickname.

Continuing to refer to FIG. 3, after the message processor clicks the message reply control, the message processing client automatically adds the account nickname “Shanyexiaocai” of the target audience client to the message reply input box.

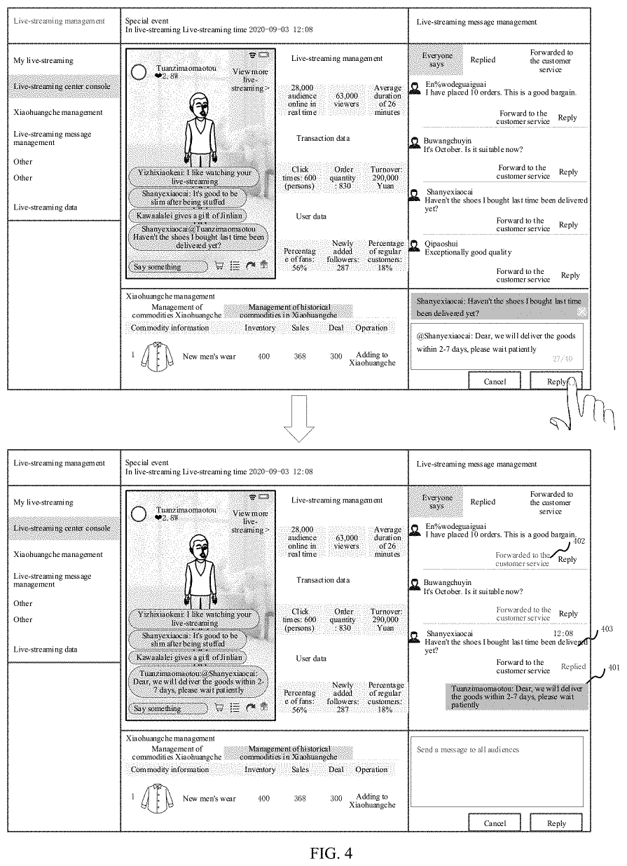

FIG. 4 is a schematic diagram of replying to the target interaction message according to an embodiment of the present disclosure. As shown in FIG. 4, the message processor continues to input interaction reply content in the message reply input box, such as “Dear, we will deliver the goods within 2-7 days, please wait patiently ˜” in FIG. 4, such that the message processing client can generate the second interaction message based on the interaction reply content and the identifier of the target audience client. After acquiring a triggering operation on the message sending control (such as the “Reply” button in FIG. 4), the message processing client sends the second interaction message to the target audience client.

In some embodiments, an editing control is displayed in the message reply region, such that the message processor can edit the interaction reply content and the identifier, such as changing font and color, etc.

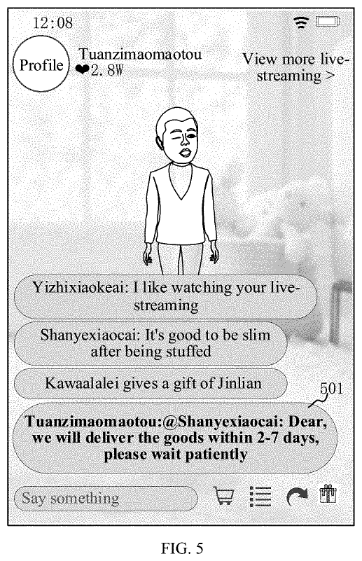

In some embodiments, after receiving the second interaction message sent from the server, the target audience client may render the second interaction message based on a preset message displaying style, and may display the rendered second interaction message on the current live-streaming page. The message displaying style includes a displaying color, a displaying font, and the like. In some embodiments, the message displaying style of the second interaction message is different from that of other messages on the live-streaming page, which is convenient for the audience to read the second interaction message quickly. FIG. 5 is a schematic diagram of the second interaction message displayed by the audience client according to an embodiment of the present disclosure, the second interaction message 501 is displayed on the current live-streaming page in a bold font style.

In some embodiments, the audience client fixedly displays the second interaction message at a preset position of the current live-streaming page until a displaying duration reaches a preset duration; and the preset position is disposed at the top or bottom of all messages.

In some embodiments, when processing the target interaction message, the message processing client continuously sends a plurality of interaction messages to the target audience client within a preset period (for example, within 10 seconds). After receiving the plurality of interaction messages sent continuously, the target audience client aggregates the plurality of interaction messages to form a second interaction message, and displays the second interaction message acquired by aggregation on the live-streaming page.

As the second interaction message is generated based on the identifier of the audience client and the interaction reply content input by the message processor, the directivity of the second interaction message can be more clear, which is helpful for the audience to read the second interaction message quickly. Further, as the audience client displays the second interaction message in a way distinct from other messages, it is convenient for the audience to quickly read a reply message, thereby improving the message interaction efficiency.

In some embodiments, during the input of the interaction reply content, the target interaction message is displayed in the message reply region.

In some embodiments, after acquiring the message reply operation on the target interaction message, the message processing client displays the target interaction message in the message reply region. Continuing to refer to FIGS. 3 and 4, during input of the interaction reply content by the message processor, the target interaction message “Shanyexiaocai: Haven't the shoes I bought last time been delivered yet?” sent from the target audience client. is displayed in the message reply region.

In some embodiments, a message closing control is set for the target interaction message in the message reply region, such that the message processor can trigger a closing operation by the message closing control to cancel the display of the target interaction message in the message reply region.

As the target interaction message is displayed in the message reply region, it is convenient for the message processor to read the target interaction message during replying the message, thereby improving the convenience in message processing, enabling a message processing function of an application program to be more comprehensive.

In some embodiments, after acquiring the second interaction message by means of the message reply input box, the second interaction message is displayed in a displaying region of the target interaction message.

In some embodiments, after sending the second interaction message to the target audience client, the message processing client synchronously displays the second interaction message in the displaying region of the target interaction message. Continuing to refer to FIG. 4, as shown at 401 in FIG. 4, after the message processor triggers the message sending instruction, the message processing client synchronously updates the second interaction message such as “Dear, we will deliver the goods within 2-7 days, please wait patiently˜” to the displaying region of the target interaction message.

As the second interaction message that has been replied to is displayed correspondingly in the displaying region of the first interaction message, it is convenient for the message processor to check session records subsequently, thereby enabling a message interaction function of the application program to be more comprehensive.

In some embodiments, before in response to the message processing instruction on the target interaction message in the first interaction message, a mass-texting reply message is acquired by means of the message reply input box. In response to a message sending instruction on the mass-texting reply message, the mass-texting reply message is sent. in a group to audience clients corresponding to the live-streaming room.

Here, the audience clients corresponding to the live-streaming room may refer to the audience clients that have entered the live-streaming room at present, and there are multiple audience clients. The mass-texting reply message means to reply to these audience clients at the same time.

In some embodiments, before the message processing client acquires the message processing instruction for the target interaction message, an initial state of the message processing client is a mass-texting reply state. That is, after acquiring the message sending instruction on the mass-texting reply message, the message processing client automatically sends content in the message reply input box to the audience clients corresponding to the current live-streaming room. Continuing to refer to FIG. 3, before the message processor triggers the message reply operation, a prompt message of “Send a message to all audiences” is displayed in the message reply input box in the message reply region 304 to instruct the message processor to input the mass-texting reply message by means of the message reply input box at this time and send the mass-texting reply message to the audience clients corresponding to the current live-streaming room.

In some embodiments, after receiving the mass-texting reply message, each audience client may display the mass-texting reply message with reference to the message displaying style shown at 501 in FIG. 5.

By configuring a mass-texting message function, the message processor can send the message in a group to all audience clients by the message processing client, thereby improving the message processing efficiency, and enabling the message interaction function to be more comprehensive.

In some embodiments, the message processing instruction is a message forwarding instruction. A message processing request is sent to a third-party message processing client in response to the message forwarding instruction, wherein the message processing request carries the target interaction message; and the third-party message processing client is configured to generate the second interaction message by processing the target interaction message, and send the second interaction message to a target audience client of the target interaction message.

Here, the third-party client is another client associated with the message processing client. For example, if the current live-streaming topic is e-commerce live-streaming, the third-party client may be an e-commerce customer service client. The message processing client may forward the target interaction message to the third-party client to allow the third-party client to reply to the target interaction message.

In some embodiments, the message processing client provides a message forwarding control, receives a message forwarding instruction by the message forwarding control, and sends a message processing request to the third-party client, wherein the message processing request carries a target interaction message. After receiving the message processing request, the third-party client displays the target interaction message on a third-party message processing page. The target interaction message is replied to by means of the third-party message processing page to generate a second interaction message. The third-party client sends the second interaction message to the server, and the server sends the second interaction message to the target audience client.

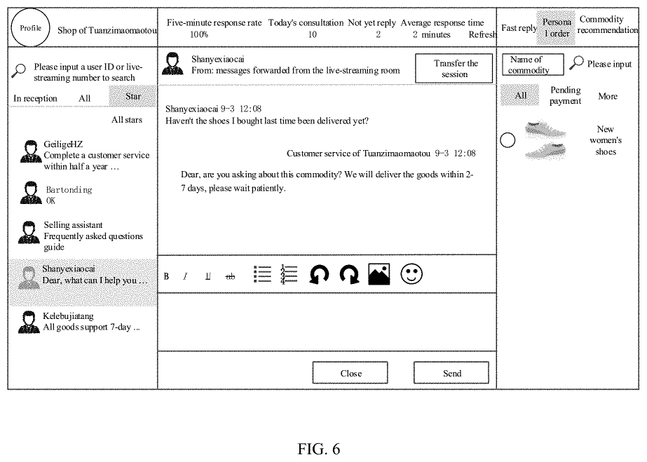

FIG. 6 is a schematic diagram of a third-party message processing page according to an embodiment of the present disclosure. As shown in FIG. 6, the third-party client updates the received target interaction message to a session corresponding to the target audience client. A third-party person may input the second interaction message by the third-party message processing page. After the third-party person clicks a sending control, the third-party client sends the second interaction message to the target audience client by means of the server.

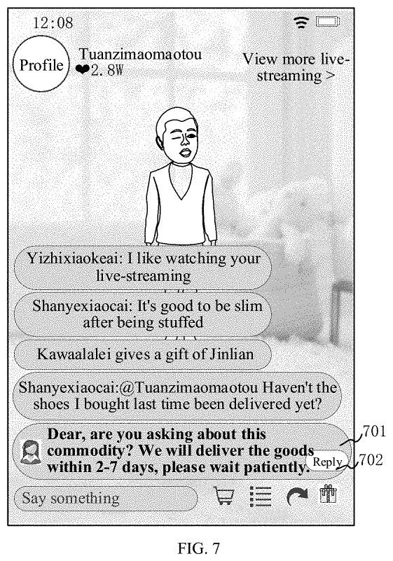

FIG. 7 is a schematic diagram of the second interaction message sent from the third-party client and displayed by the target audience client according to an embodiment of the present disclosure. As shown in FIG. 7, the audience client renders the second interaction message 701 based on a preset message displaying style, and displays the rendered second interaction message at a preset position on the live-streaming page.

In some embodiments, the audience client fixedly displays the second interaction message at a preset position of the current live-streaming page until a displaying duration reaches a preset duration; and the preset position is disposed at the top or bottom of all messages.

In some embodiments, when processing the target interaction message, the third-party client continuously sends a plurality of interaction messages to the audience client within a preset period. After receiving the plurality of interaction messages sent continuously, the audience client aggregates the plurality of interaction messages to form a second interaction message, and displays the second interaction message acquired by aggregation on the live-streaming page.

in some embodiments, continuing to refer to FIG. 7, a reply control 702 may be configured on the live-streaming page of the audience client, such that the audience client. can directly have a session with the third-party client on the current live-streaming page by triggering the reply control.

The message processing client is connected to the associated third-party client, and the associated third-party client directly participates in an interaction message sent from the audience client, such that the response to the audience message can be timely and accurate, thereby shortening the message processing time among the audience, the message processor and the third-party person, and improving the message interaction efficiency.

In some embodiments, after the target interaction message is processed, the display state of the message processing control is adjusted, wherein the display state is configured to indicate the processing progress of the target interaction message.

Here, the display state of the message control may be characterized by a color, a prompt character, etc. The processing progress is not limited to a processed state, an unprocessed state, a processing state, etc. For example, in response to the triggering operation on the message processing control, after the target interaction message is processed, the message processing client correspondingly adjusts the display state of the message processing control based on the current processing progress. As shown at 402 in FIG. 4, after forwarding the first interaction message corresponding to an account “En %wodeguaiguai”, the message processing client adjusts the display state of the message forwarding control automatically from “Forward to the customer service” to “Forwarded to the customer service”, and the display color is changed from black to gray. Similarly, as shown at 403 in FIG. 4, the message processing client automatically adjusts the display state of the message reply control from “Reply” to “Replied”, and changes the display color from black to gray.

By changing the display state of the message processing control based on a processing situation of the first interaction message to intuitively display a message processing progress, it is convenient for the message processor to acquire a message processing situation, thereby improving the message processing efficiency and avoiding the omission in message processing.

In some embodiments, after the target interaction message is processed, the target interaction message is updated to the message processed page of the message processing client.

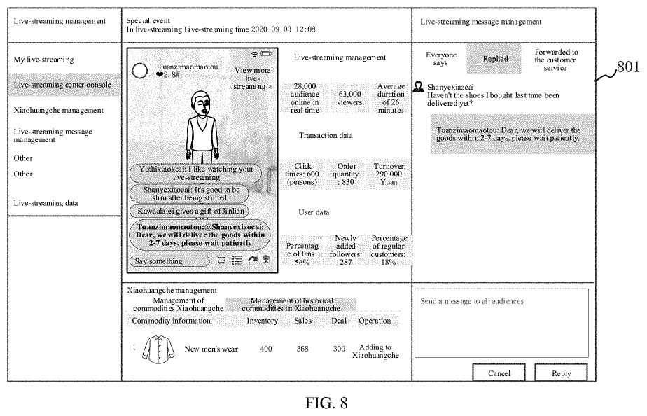

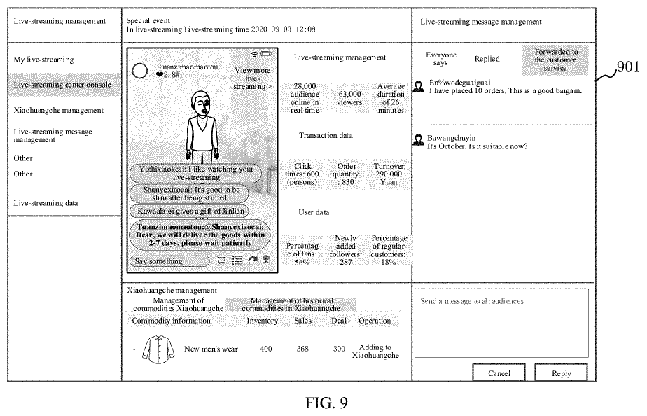

In some embodiments, the page displayed by the message processing client further includes a message processed page. After determining that the target interaction message is processed, the message processing client updates the processed target interaction message to the message processed page. FIGS. 8 and 9 show a schematic diagram of a message processed page. As shown in FIG. 8, the message processing client updates the replied first interaction message and the corresponding second interaction message and the updated status is shown on a message processed page 801, which indicates “Replied” in the section “Live-stream message management”. As shown in FIG. 9, the message processing client updates the first interaction message forwarded to the third-party client to a customer service and the updated status is shown on a message processed page 901, which indicates “Forwarded to the customer service” in the section “Live-stream message management”.

By displaying the processed messages in an aggregated fashion, it is convenient for the message processor to view historical reply records, such that the operability of message processing is improved.

In the embodiments of the present disclosure, the first interaction message and the second interaction message are private chat messages.

In some embodiments, after receiving the first interaction message sent from the audience client when the message interaction control is in the activated state, the server unidirectionally sends the first interaction message to the message processing client. After receiving the second interaction message sent from the message processing client or the third-party client, the server unidirectionally sends the second interaction message to the audience client based on the account information of the audience client.

In some embodiments, the server may further send the first interaction message and the second interaction message to an anchor client, such that an anchor can know the message interaction situation in real time.

By transmitting the first interaction message and the second interaction message in the form of the private chat messages, it is realized that other audiences are not affected while the audience messages are processed in time; and meanwhile the privacy of the audience messages is protected.

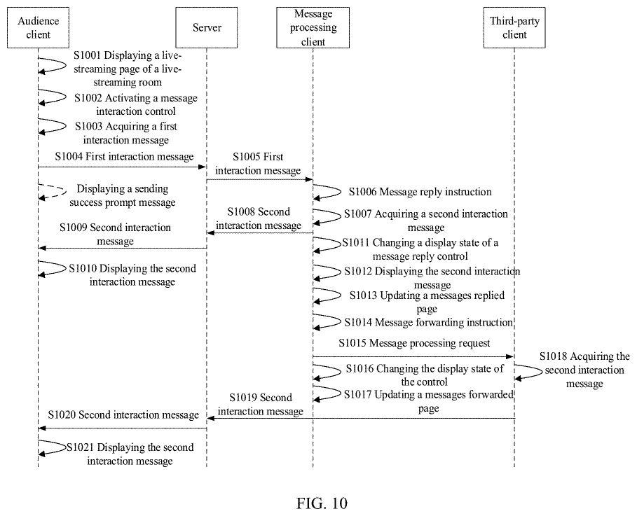

FIG. 10 is an interaction diagram of a method for message interaction according to an embodiment of the present disclosure. As shown in FIG. 10, the method for interacting the messages is applicable to a system including an audience client, a server, a message processing client and a third-party client, and includes the following steps.

In S1001, the audience client displays a live-streaming page of a live-streaming room, and a message interaction control in an inactivated state is displayed on the live-streaming page.

In S1002, the audience client changes the state of the message interaction control from the inactivated state to an activated state in response to a triggering operation on the message interaction control.

In S1003, the audience client acquires a first interaction message when the message interaction control is in the activated state.

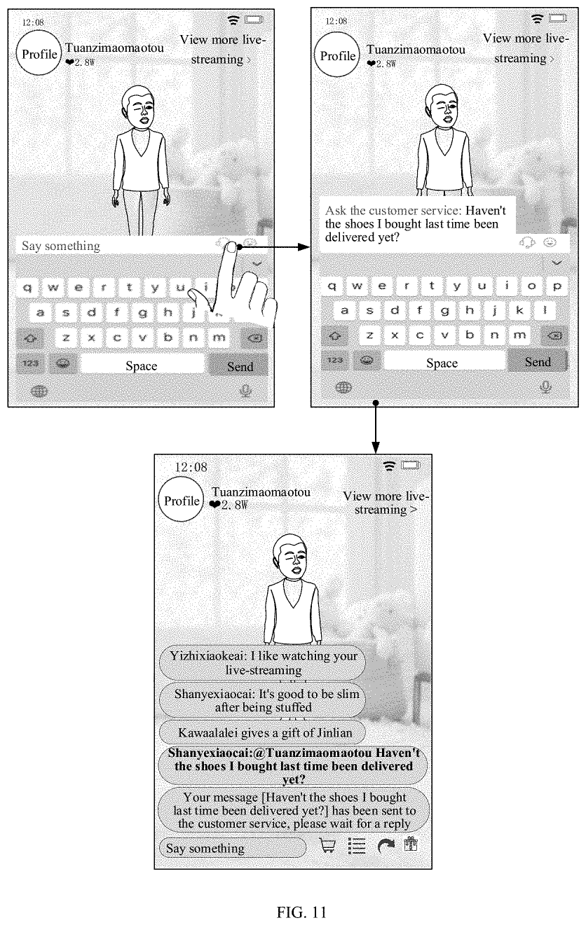

As shown in FIG. 11, the message interaction control is displayed in the message input box at the audience client, and has an initial state of being inactivated. An audience clicks the message interaction control, such that the audience client can change the state of the message interaction control to the activated state. Continuing to refer to FIG. 11, after the message interaction control is activated, a text “Ask a customer service” automatically appears in the message input box. The audience may input the content of the first interaction message, such as “Haven't the shoes I bought last time been delivered yet?” in the message input box.

In some embodiments, in the case that the audience clicks the message interaction control again, the audience client changes the state of the message interaction control to the inactivated state, and cancels the text “Ask a customer service”.

In S1004, the audience client sends the first interaction message to the server in response to a message sending instruction on the first interaction message.

In S1005, the server sends the first interaction message to the message processing client corresponding to a live-streaming room.

Continuing to refer to FIG. 11, after sending the first interaction message to the message processing client, the audience client displays a prompt message on the live-streaming page, such as “Your message [Haven't the shoes I bought last time been delivered yet?] has been sent to the customer service, please wait for a reply” to remind the audience that the first interaction message has been sent successfully.

In S1006, the message processing client receives the at least one first interaction message, and replies or forwards a target interaction message in the at least one first interaction message. In the case of the reply processing, the message processing client receives a message reply instruction by a message reply control.

in S1007, the message processing client acquires a second interaction message by a message reply input box.

In S1008, the message processing client sends the second interaction message to the server in response to a message sending instruction on the second interaction message.

In S1009, the server sends the second interaction message to a target audience client.

In S1010, the target audience client displays the second interaction message, which may refer to FIG. 5, and is not described in detail herein.

In S1011, the message processing client adjusts a display state of the message reply control, which may refer to 403 in FIG. 4, and is not repeated herein.

In S1012, the message processing client displays the second interaction message in a displaying region of the target interaction message, which may refer to 401 in FIG. 4, and is not repeated herein.

In S1013, the message processing client updates the target interaction message to a message replied page of the message processing client, which may refer to FIG. 8, and is not repeated herein.

In S1014, if the message processing client forwards the target interaction message, the message processing client receives a message forwarding instruction by a message forwarding control.

In S1015, the message processing client sends a message processing request to the third-party client, wherein the message processing request carries the target interaction message.

In S1016, the message processing client changes the display state of the message forwarding control, which may refer to 402 in FIG. 4, and is not repeated herein.

In S1017, the message processing client updates the target interaction message to a message forwarded page, which may refer to FIG. 9, and is not repeated herein.

In S1018, the third-party client replies to the target interaction message to generate a second interaction message, which may refer to FIG. 6, and is not repeated herein.

In S1019, the third-party client sends the second interaction message to the server.

In S1020, the server sends the third-party interaction message to the audience client.

In S1021, the audience client displays the second interaction message, which may refer to FIG. 7, and is not repeated herein.

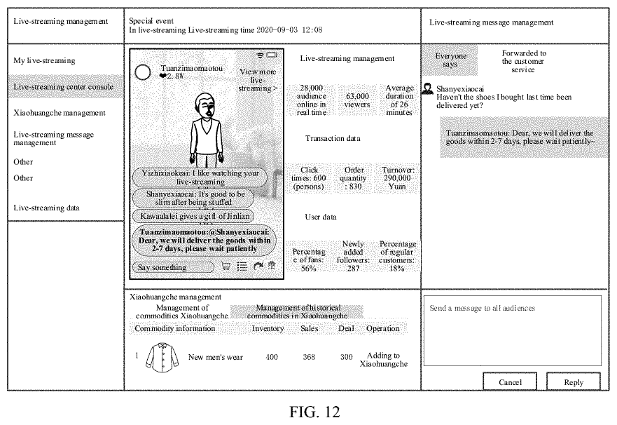

In some embodiments, after the live-streaming ends, the message processing page of the message processing client displays a message processing details page. As shown in FIG. 12, the message processing client displays the processed messages in an aggregated fashion on the replied page and the forwarded page.

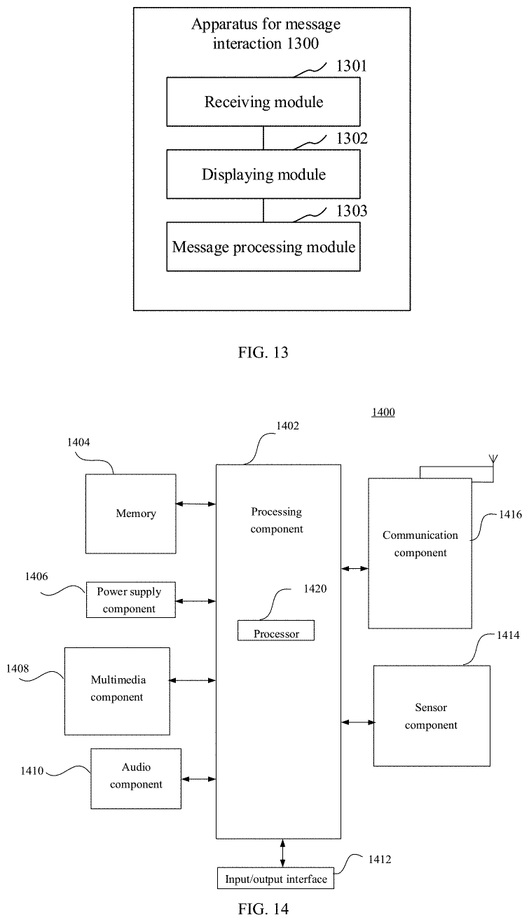

FIG. 13 is a block diagram of an apparatus 1300 for message interaction according to an embodiment of the present disclosure. Referring to FIG. 13, the apparatus includes a receiving module 1301, a displaying module 1302, and a message processing module 1303.

The receiving module 1301 is configured to receive at least one first interaction message, wherein the at least one first interaction message is sent from an audience client in a live-streaming room.

The displaying module 1302 is configured to display the at least one first interaction message on a message processing page.

The message processing module 1303 is configured to acquire a second interaction message for a target interaction message in response to a message processing instruction on the target interaction message, wherein the target interaction message includes a first interaction message selected on the message processing page.

The apparatus 1300 further includes: a sending module, configured to send the second interaction message to a target audience client in response to a message sending instruction on the second interaction message, wherein the target audience client includes an audience client sending the target interaction message.

In some embodiments, the message processing module 1303 is configured to acquire the second interaction message for the target, interaction message by processing the target interaction message in response to a triggering operation on a message processing control corresponding to the target interaction message.

In some embodiments, the apparatus 1300 further includes: a state changing module, configured to adjust a display state of the message processing control, wherein the display state is configured to indicate a processing progress of the target interaction message.

In some embodiments, the message processing instruction includes a message reply instruction. The message processing module 1303 is configured to acquire the second interaction message by a message reply input box in response to the message reply instruction, wherein the message reply input box is displayed in a message reply region on the message processing page.

In some embodiments, the message processing module 1303 includes: a message content acquiring unit configured to acquire interaction reply content and an identifier of the target audience client by the message reply input box, wherein the identifier is added into the message reply input box based on the message reply instruction; and a message generating unit configured to generate the second interaction message based on the identifier and the interaction reply content.

In some embodiments, the displaying module 1302 is further configured to display the target interaction message in a message reply region.

In some embodiments, the displaying module 1302 is further configured to display the second interaction message in a displaying region of the target interaction message.

In some embodiments, the apparatus 1300 further includes a mass-texting message acquiring module configured to acquire a mass-texting reply message by the message reply input box; and a message group sending module, configured to send in a group the mass-texting reply message to the audience client in the live-streaming room in response to a message sending instruction on the mass-texting reply message.

In some embodiments, the message processing instruction includes a message forwarding instruction. The message processing module 1303 is configured to send a message processing request to a third-party message processing client in response to the message forwarding instruction, wherein the message processing request carries the target interaction message, and the third-party message processing client is configured to generate the second interaction message by processing the target interaction message, and send the second interaction message to the target audience client.

In some embodiments, the apparatus 1300 further includes a message updating module configured to update the target interaction message to a message processed page of the message processing client.

With respect to the apparatus in the above embodiments, the specific manners for individual modules in the apparatus to perform operations have been described in detail in the embodiments of the related methods, and will not be elaborated herein.

An electronic device is further provided according to an embodiment of e present disclosure, the electronic device includes:

a processor; and

a memory configured to store at least one instruction executable by the processor,

wherein the processor, when loading and executing the at least one instruction, is caused to perform:

receiving at least one first interaction message, wherein the at least one first interaction message is sent from an audience client in a live-streaming room;

displaying the at least one first interaction message on a message processing page;

acquiring a second interaction message for a target interaction message in response to a message processing instruction on the target interaction message, wherein the target interaction message includes a first interaction message selected on the message processing page; and

sending the second interaction message to a target audience client in response to a message sending instruction on the second interaction message, wherein the target audience client includes an audience client sending the target interaction message.

In some embodiments, the processor, when loading and executing the at least one instruction, is further caused to perform:

acquiring the second interaction message for the target interaction message by processing the target interaction message in response to a triggering operation on a message processing control corresponding to the target interaction message.

In some embodiments, the processor, when loading and executing the at least one instruction, is further caused to perform:

adjusting a display state of the message processing control, wherein the display state is configured to indicate a processing progress of the target interaction message.

In some embodiments, the message processing instruction includes a message reply instruction. The processor, when loading and executing the at least one instruction, is further caused to perform:

acquiring the second interaction message by a message reply input box in response to the message reply instruction, wherein the message reply input box is displayed in a message reply region on the message processing page.

In some embodiments, the processor, when loading and executing the at least one instruction, is further caused to perform:

acquiring interaction reply content and an identifier of the target audience client by the message reply input box, wherein the identifier is added into the message reply input box based on the message reply instruction; and

generating the second interaction message based on the identifier and the interaction reply content.

In some embodiments, the processor, when loading and executing the at least one instruction, is further caused to perform:

displaying the target interaction message in the message reply region.

In some embodiments, the processor, when loading and executing the at least one instruction, is further caused to perform:

displaying the second interaction message in a displaying region of the target interaction message.

In some embodiments, the processor, when loading and executing the at least one instruction, is further caused to perform:

acquiring a mass-texting reply message by the message reply input box; and

sending in a group the mass-texting reply message to the audience client in the live-streaming room in response to a message sending instruction on the mass-texting reply message.

In some embodiments, the message processing instruction includes a message forwarding instruction.

The processor, when loading and executing the at least one instruction, is further caused to perform:

sending a message processing request to a third-party message processing client in response to the message forwarding instruction, wherein

the message processing request carries the target interaction message, and the third-party message processing client is configured to generate the second interaction message by processing the target interaction message, and send the second interaction message to the target audience client.

In some embodiments, the processor, when loading and executing the at least one instruction, is further caused to perform:

updating the target interaction message to a message processed page of the message processing client.

FIG. 14 is an internal structure diagram of an electronic device according to an exemplary embodiment. Fox example, the electronic device 1400 may be a mobile phone, a computer, a digital broadcast terminal, a message transceiver, a game console, a tablet device, a medical device, fitness equipment, a personal digital assistant, or the like.

Referring to FIG. 14, the electronic device 1400 may include one or more following components: a processing component 1402, a memory 1404, a power supply component 1406, a multimedia component 1408, an audio component 1410, an input/output (I/O) interface 1412, a sensor component 1414, and a communication component 1416.

he processing component 1402 typically controls overall operations of the electronic device 1400, such as the operations associated with display, telephone calls, data communications, camera operations and recording operations. The processing component 1402 may include one or more processors 1420 to execute instructions to realize all or part of the steps in the above-described methods. Moreover, the processing component 1402 may include one or more modules that facilitate the interaction between the processing component 1402 and other components. For example, the processing component 1402 may include a multimedia module to facilitate the interaction between the multimedia component 1408 and the processing component 1402.

The memory 1404 is configured to store various types of data to support the operation of the apparatus 1400. Examples of such data include instructions for any applications or methods operated on the electronic device 1400, contact data, phonebook data, messages, pictures, videos, etc. The memory 1404 may be implemented by using any type of transitory or non-transitory memory equipment, or a combination thereof, such as a static random-access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power supply component 1406 provides power to various components of the electronic device 1400. The power supply component 1406 includes a power supply management system, one or more power supplies, and any other components associated with the generation, management, and distribution of power in the electronic device 1400.

The multimedia component 1408 includes a screen providing an output interface between the electronic device 1400 and a user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes and gestures on the touch panel. The touch sensors may not only sense a boundary of a touch or swipe action, but also sense a period and a pressure associated with a touch or swipe action. In some embodiments, the multimedia component 1408 includes a front camera and/or a rear camera. The front camera and/or the rear camera may receive an external multimedia datum while the electronic device 1400 is in an operation mode, such as a photographing mode or a video mode. Each of the front and rear cameras may be a fixed optical lens system or have a focus and optical zoom capability.

The audio component 1410 is configured to output and/or input audio signals. For example, the audio component 1410 includes a microphone (MIC) configured to receive an external audio signal when the electronic device 1400 is in an operation mode, such as a call mode, a recording mode, and a voice recognition mode. The received audio signal may be further stored in the memory 1404 or transmitted via the communication component 1416. In some embodiments, the audio component 1410 may further include a speaker configured to output audio signals.

The I/O interface 1412 provides an interface between the processing component 1402 and peripheral interface modules, such as a keyboard, a click wheel, buttons, and the like. The buttons may include, but are not limited to, a home button, a volume button, a starting button, and a locking button.

The sensor component 1414 includes one or more sensors to provide the electronic device 1400 with status assessments of various aspects. For instance, the sensor component 1414 may detect an open/closed status of the electronic device 1400, relative positioning of components, e.g., a display and a keypad, of the electronic device 1400, a change in position of the electronic device 1400 or a component of the electronic device 1400, a presence or absence of user's contact with the electronic device 1400, art orientation or an acceleration/deceleration of the electronic device 1400, and a change in temperature of the electronic device 1400. The sensor component 1414 may include a proximity sensor configured to detect the presence of nearby objects without any physical contact. The sensor component 1414 may further include a light sensor, such as a CMOS or CCD image sensor, for use in imaging applications. In some embodiments, the sensor component 1414 may further include an accelerometer sensor, a gyroscope sensor, a magnetic sensor, a pressure sensor, or a temperature sensor.

The communication component 1416 is configured to facilitate wired or wireless communication between the electronic device 1400 and other devices. The electronic device 1400 accesses a wireless network based on a communication standard, such as WiFi, an operator network (such as 2G, 3G, 4G or 5G), or a combination thereof. In an exemplary embodiment, the communication component 1416 receives a broadcast signal or broadcast associated information from an external broadcast management system via a broadcast channel. In an exemplary embodiment, the communication component 1416 further includes a near field communication (NFC) module to facilitate short-range communications. For example, the NFC module may be implemented based on the radio frequency identification (RFID) technology, infrared data association (IrDA) technology, ultra-wideband (UWB) technology, Bluetooth (BT) technology, and other technologies.

In some embodiments, the electronic device 1400 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above method.

A non-transitory storage medium storing at least one instruction is further provided, such as a memory 1404 including the at least one instruction, according to an embodiment of the present disclosure. For example, the non-transitory storage medium may be an ROM, a random-access storage (RAM), a CD-ROM, a magnetic tape, a floppy disc, an optical data storage device, and the like. The at least one instruction, when loaded and executed by a processor 1420 of an electronic device 1400, causes the electronic device 1400 to perform:

receiving at least one first interaction message, wherein the at least one first interaction message is sent from an audience client in a live-streaming room;

displaying the at least one first interaction message on a message processing page;

acquiring a second interaction message for a target interaction message in response to a message processing instruction on the target interaction message, wherein the target interaction message includes a first interaction message selected on the message processing page; and

sending the second interaction message to a target audience client in response to a message sending instruction on the second interaction message, wherein the target audience client includes an audience client sending the target interaction message.

In some embodiments, the at least one instruction, when loaded and executed by a processor of an electronic device, causes the electronic device to perform:

acquiring the second interaction message for the target interaction message by processing the target interaction message in response to a triggering operation on a message processing control corresponding to the target interaction message.

In some embodiments, the at least one instruction, when loaded and executed by a processor of an electronic device, causes the electronic device to perform:

adjusting a display state of the message processing control, wherein the display state is configured to indicate a processing progress of the target interaction message.

In some embodiments, the message processing instruction includes a message reply instruction. The at least one instruction, when loaded and executed by a processor of an electronic device, causes the electronic device to perform:

acquiring the second interaction message by a message reply input box in response to the message reply instruction, wherein the message reply input box is displayed in a message reply region on the message processing page.

In some embodiments, the at least one instruction, when loaded and executed by a processor of an electronic device, causes the electronic device to perform:

acquiring interaction reply content and an identifier of the target audience client by the message reply input box, wherein the identifier is added into the message reply input box based on the message reply instruction; and

generating the second interaction message based on the identifier and the interaction reply content.

In some embodiments, the at least one instruction, when loaded and executed by a processor of an electronic device, causes the electronic device to perform:

displaying the target interaction message in the message reply region.

In some embodiments, the at least one instruction, when loaded and executed by a processor of an electronic device, causes the electronic device to perform:

displaying the second interaction message in a displaying region of the target interaction message.

In some embodiments, the at least one instruction, when loaded and executed by a processor of an electronic device, causes the electronic device to perform:

acquiring a mass-texting reply message by the message reply input box; and

sending in group the mass-texting reply message to the audience client in the live-streaming room in response to a message sending instruction on the mass-texting reply message.

In some embodiments, the message processing instruction includes a message forwarding instruction.

The at least one instruction, when loaded and executed by a processor of an electronic device, causes the electronic device to perform:

sending a message processing request to a third-party message processing client in response to the message forwarding instruction, wherein

the message processing request carries the target interaction message, and the third-party message processing client is configured to generate the second interaction message by processing the target interaction message, and send the second interaction message to the target audience client.

In some embodiments, the at least one instruction, when loaded and executed by a processor of an electronic device, causes the electronic device to perform:

updating the target interaction message to a message processed page of the message processing client.

A computer program product including a computer program stored in a readable storage medium is provided according to an embodiment of the present disclosure, wherein the computer program, when read and executed by at least one processor of an electronic device from the readable storage medium, causes the electronic device to perform the above method.

Other embodiments of the present disclosure will be apparent to those skilled in the art from consideration of the description and practice of the present disclosure. The present disclosure is intended to cover any variations, uses, or adaptations of the present disclosure following the general principles thereof, and is intended to include common knowledge or commonly used technical measures in the art which are not disclosed herein. The description and the embodiments are to be considered as exemplary only, with a true scope and spirit of the present disclosure being indicated by the following claims.

It will be appreciated that the present disclosure is not limited to the exact construction that has been described above and illustrated in the accompanying drawings, and that various modifications and changes can be made without departing from the scope thereof. The scope of the present disclosure is only subject to the appended claims.

What is claimed is:

1. A method for message interaction, applicable to a message processing client, the method comprising:
receiving at least one first interaction message, wherein the at least one first interaction message is sent from an audience client in a live-streaming room;
displaying the at least one first interaction message on a message processing page;
acquiring a second interaction message for a target interaction message in response to a message processing instruction on the target interaction message, wherein the target interaction message comprises a first interaction message selected on the message processing page; and
sending the second interaction message to a target audience client in response to a message sending instruction on the second interaction message, wherein the target audience client is an audience client sending the target interaction message.

2. The method according to claim 1, wherein said acquiring the second interaction message for the target interaction message in response to the message processing instruction on the target interaction message comprises:
acquiring the second interaction message for the target interaction message by processing the target interaction message in response to a triggering operation on a message processing control corresponding to the target interaction message.

3. The method according to claim 2, further comprising:
adjusting a display state of the message processing control, wherein the display state is configured to indicate a processing progress of the target interaction message.

4. The method according to claim 1, wherein the message processing instruction comprises a message reply instruction; and
said acquiring the second interaction message for the target interaction message in response to the message processing instruction on the target interaction message comprises:
acquiring the second interaction message by a message reply input box in response to the message reply instruction, wherein the message reply input box is displayed in a message reply region on the message processing page.

5. The method according to claim 4, wherein said acquiring the second interaction message by the message reply input box comprises:
acquiring interaction reply content and an identifier of the target audience client by the message reply input box, wherein the identifier is added into the message reply input box based on the message reply instruction; and
generating the second interaction message based on the identifier and the interaction reply content.

6. The method according to claim 4, further comprising:
displaying the target interaction message in the message reply region.

7. The method according to claim 4, further comprising:
displaying the second interaction message in a display region of the target interaction message.

8. The method according to claim 4, further comprising:
acquiring a mass-texting reply message by the message reply input box; and
sending in group the mass-texting reply message to the audience client in the live-streaming room in response to a message sending instruction on the mass-texting reply message.

9. The method according to claim 1, wherein the message processing instruction comprises a message forwarding instruction; and
said acquiring the second interaction message for the target interaction message in response to the message processing instruction on the target interaction message comprises:
sending a message processing request to a third-party message processing client in response to the message forwarding instruction, wherein the message processing request carries the target interaction message, and the third-party message processing client is configured to generate the second interaction message by processing the target interaction message, and send the second interaction message to the target audience client.

10. The method according to claim 1, wherein in response to processing the target interaction message, the method further comprises:
updating the target interaction message to a message processed page of the message processing client.

11. An electronic device, comprising:
a processor; and
a memory configured to store at least one instruction executable by the processor;
wherein the processor, when loading and executing the at least one instruction, is caused to perform:
receiving at least one first interaction message, wherein the at least one first interaction message is sent from an audience client in a live-streaming room;
displaying the at least one first interaction message on a message processing page;
acquiring a second interaction message for a target interaction message in response to a message processing instruction on the target interaction message, wherein the target interaction message comprises a first interaction message selected on the message processing page; and
sending the second interaction message to a target audience client in response to a message sending instruction on the second interaction message, wherein the target audience client comprises an audience client sending the target interaction message.

12. The electronic device according to claim 11, wherein the processor, when loading and executing the at least one instruction, is further caused to perform:
displaying, by the target audience client, the second interaction message on a live-streaming page of the live-streaming room.

13. The electronic device according to claim 11, wherein the processor, when loading and executing the at least one instruction, is further caused to perform:
acquiring the second interaction message for the target interaction message by processing the target interaction message in response to a triggering operation on a message processing control corresponding to the target interaction message.

14. The electronic device according to claim 13, wherein the processor, when loading and executing the at least one instruction, is further caused to perform:
adjusting a display state of the message processing control, wherein the display state is configured to indicate a processing progress of the target interaction message.

15. The electronic device according to claim 13, wherein the message processing instruction comprises a message reply instruction; and the processor, when loading and executing the at least one instruction, is further caused to perform:
acquiring the second interaction message by a message reply input box in response to the message reply instruction, wherein the message reply input box is displayed in a message reply region on the message processing page.

16. The electronic device according to claim 15, wherein the processor, when loading and executing the at least one instruction, is further caused to perform:
acquiring interaction reply content and an identifier of the target audience client by the message reply input box, wherein the identifier is added into the message reply input box based on the message reply instruction; and
generating the second interaction message based on the identifier and the interaction reply content.

17. The electronic device according to claim 15, wherein the processor, when loading and executing the at least one instruction, is further caused to perform:
displaying the target interaction message in the message reply region.

18. The electronic device according to claim 15, wherein the processor, when loading and executing the at least one instruction, is further caused to perform:
displaying the second interaction message in a display region of the target interaction message.

19. The electronic device according to claim 15, wherein the processor, when loading and executing the at least one instruction, is further caused to perform:
acquiring a mass-texting reply message by the message reply input box; and
sending in group the mass-texting reply message to the audience client in the live-streaming room in response to a message sending instruction on the mass-texting reply message.

20. A non-transitory storage medium storing at least one instruction therein, wherein the at least one instruction, when loaded and executed by a processor of an electronic device, causes the electronic device to perform:
receiving at least one first interaction message, wherein the at least one first interaction message is sent from an audience client in a live-streaming room;
displaying the at least one first interaction message on a message processing page;
acquiring a second interaction message for a target interaction message in response to a message processing instruction on the target interaction message, wherein the target interaction message comprises a first interaction message selected on the message processing page; and
sending the second interaction message to a target audience client in response to a message sending instruction on the second interaction message, wherein the target audience client comprises an audience client sending the target interaction message.
